(19) United States
(12) Patent Application Publication
(10) Pub. No.: US 2025/0114177 A1
(43) Pub. Date: Apr. 10, 2025

(54) TWO-HANDLE DENTAL FLOSS HOLDER

(71) Applicant: Guoqing TAO, Wuhu (CN)

(72) Inventor: Guoqing TAO, Wuhu (CN)

(21) Appl. No.: 18/785,845

(22) Filed: Jul. 26, 2024

(30) Foreign Application Priority Data
Oct. 7, 2023 (CN) 202322693684.5

(51) Int. Cl. A61C 15/04

(52) U.S. Cl. CPC A61C 15/046

(57) ABSTRACT

The embodiments of the present disclosure provide a two-handle dental floss holder, including two main bodies. Each of the two main bodies includes a handle and a winding head. The winding head is defined with a horizontal notch and a vertical notch along a top-down direction, respectively. The horizontal notch is opened upward; the vertical notch is opened sideward. A vertical bar is arranged on one side of the vertical notch, and a horizontal bar is arranged between the horizontal notch and the vertical notch.

### CROSS REFERENCE TO RELATED APPLICATIONS

This application claims priority benefits to Chinese Patent Application No. 2023226936845, filed on Oct. 7, 2023, the contents of which are incorporated herein by reference

### TECHNICAL FIELD

The present disclosure relates to the technical field of dental floss holders, and in particular, to a two-handle dental floss holder.

### BACKGROUND

Dental floss is a commonly used interdental cleaning tool, which is widely recommended by dentists at home and abroad. Dental floss on the market may be divided into two categories according to the state of use: string dental floss and bow-shaped dental floss. String dental floss is a type of dental floss wound in a box, and a section needs to be cut if it is needed to be used. Bow-shaped dental floss, also known as dental floss pick, is a product with dental floss pre-installed, and the dental floss doesn't need to be installed when a user uses it. Although the bow-shaped dental floss pick is easy to use, it is difficult to clean the back teeth. In addition, it is a disposable product and is not environmentally friendly.

### SUMMARY

A two-handle dental floss holder includes two main bodies. Each of the main bodies includes a handle and a winding head, the winding head is defined with a horizontal notch and a vertical notch along a top-down direction respectively, the horizontal notch is opened upward, the vertical notch is opened sideward, a vertical bar is arranged on one side of the vertical notch away from its opening, and a horizontal bar is arranged between the horizontal notch and the vertical notch.

### BRIEF DESCRIPTION OF DRAWINGS

The description and drawings that constitute part of the present disclosure are provided for a further understanding of the present disclosure. The illustrative embodiments and their descriptions are provided for explanation but do not constitute improper limitations of the present disclosure.

FIG. 1 is a schematic structural view according to the present disclosure.

FIG. 2 is a schematic structural view according to the present disclosure.

FIG. 3 is a schematic view of a dental tape being drawn out from a horizontal notch according to the present disclosure.

FIG. 4 is a schematic view of a dental tape being drawn out from a vertical notch according to the present disclosure.

FIG. 5 is an enlarged structural view of part A shown in FIG. 1 according to the present disclosure.

### DETAILED WAY

The present disclosure will be described in detail below with reference to the accompanying drawings and in conjunction with various embodiments. Each example is provided to explain but not limit the present disclosure. In fact, it will be clear to those of ordinary skill that modifications and variations may be made without departing from the scope or spirit of the present disclosure. For example, a feature shown or described as part of one embodiment may be used according to another embodiment to produce yet another embodiment. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientation or position relationship based on the orientation or position relationship shown in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may be a wired electrical connection, a radio connection, or a wireless communication signal connection. For those of ordinary skill in the art, the specific meanings of the above terms may be understood according to the specific circumstances.

One or more examples of the present disclosure are shown in the attached drawings. Numbers and letter signs are used in the detailed description to refer to features in the drawings. Similar marks in the drawings and descriptions have been configured to refer to similar parts of the present disclosure. As used herein, the terms “first”, “second” and “third” are used interchangeably to distinguish one component from another, and are not intended to indicate the position or importance of individual components.

### Embodiments

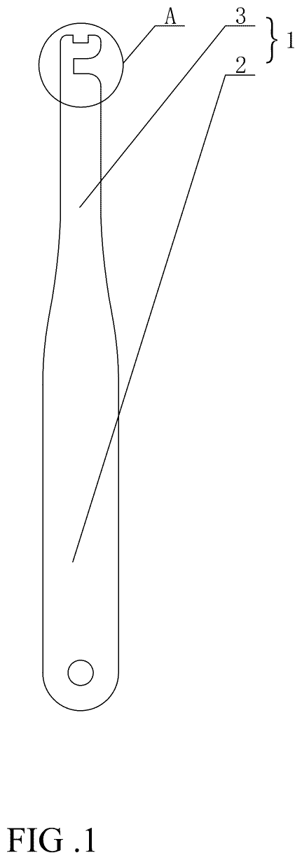

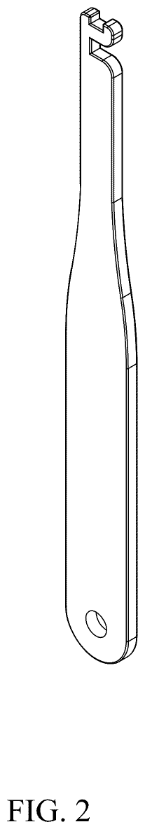

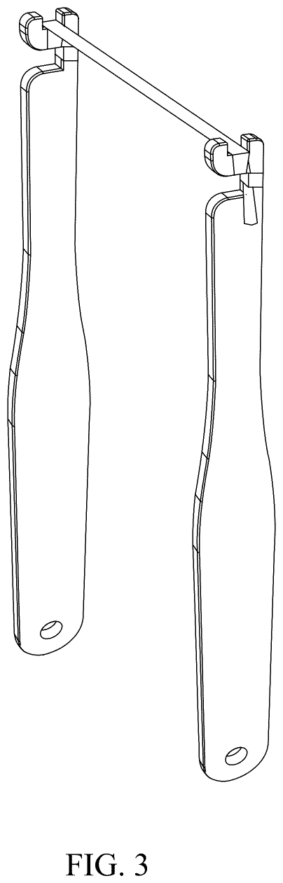

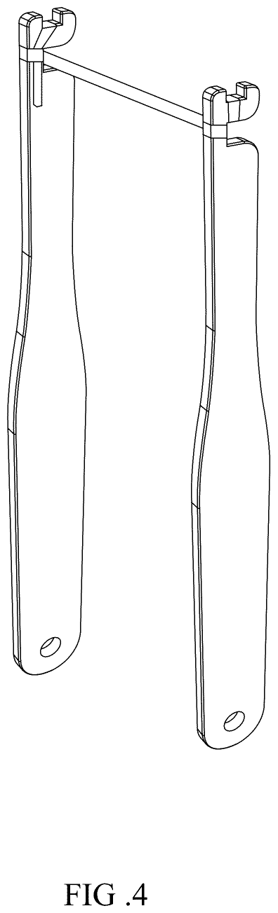

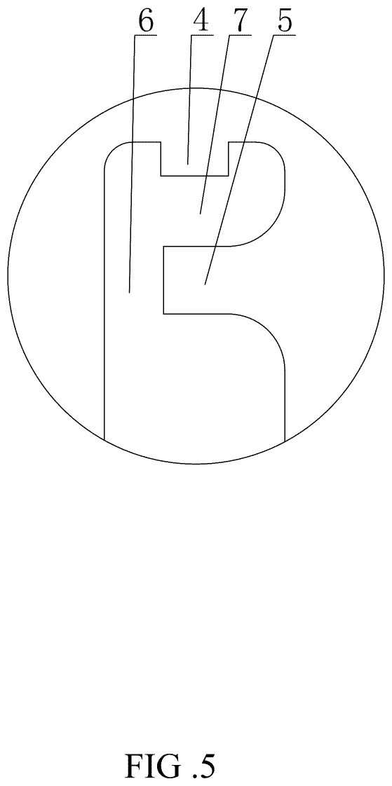

As shown in FIG. 1 to FIG. 5, according to the embodiments of the present disclosure, a two-handle dental floss holder is provided. The two-handle dental floss holder includes two main bodies 1, each of which includes a handle 2 and a winding head 3. The winding head 3 is defined with a horizontal notch 4 and a vertical notch 5 along a top-down direction. The horizontal notch 4 and the vertical notch 5 are configured to guide and constrain the dental floss. The horizontal notch 4 is opened upward, and the vertical notch 5 is opened sideward, allowing the opening directions of the horizontal notch 4 and the vertical notch 5 being perpendicular to each other. A vertical bar 6 is arranged beside the vertical notch 5 away from its opening. A horizontal bar 7 is arranged between the horizontal notch 4 and the vertical notch 5.

During use, hold each main body 1 with each hand, and the opening directions of the vertical notches 5 of the left and right main bodies 1 are opposite. Take a piece of dental floss about 12 cm long, and first wind it around the main body on the left hand. Press one tail end of the dental floss on one end of the main body 1 with the left thumb, and wind the dental floss through the horizontal notch 4 with the right hand, put it on the horizontal bar 7, and then wind through the vertical notch 5, and after 2 to 3 turns of winding around the vertical bar 6, wind through the horizontal notch 4 again, and put it on the horizontal bar 7. After that, the dental floss winding on the main body on the left hand is completed. Then, wind the dental floss around the main body on the right hand. The winding method is the same as that of the left hand. Press one tail end of the dental floss with the right thumb, wind the dental floss through the horizontal notch 4, and put it on the horizontal bar 7, and then wind through the vertical notch 5, and after 2 to 3 turns of winding around the vertical bar 6, wind around the horizontal notch 4 again, and put it on the horizontal bar 7. After that, the dental floss winding on the main body on the right hand is completed. After the above winding process, keep the dental floss with moderate tension by both hands, and the dental floss will not loosen. This method of installing dental floss is simple and fast, firm and reliable, and may save dental floss. For dental floss tape, when winding, care should be taken not to twist the tape. One side of the dental tape in contact with the main body is always in contact with the main body 1, such that the tape is not twisted.

Alternatively, a longer dental floss may be taken and the excessive part of the dental floss may be wound around the vertical bar 6 of one of the two main bodies 1, such that the contaminated dental floss may be replaced subsequently. The method is: first, the dental floss is adjusted to be led out from the vertical wire groove 5, then the main body on the left hand is rotated to release the dental floss, and the main body on the right hand is synchronously rotated to retract the dental floss. Therefore, the used dental floss may be wound up and the new dental floss may be wound out, so as to achieve the renewal of the dental floss.

The dental floss may be led out from the horizontal notches 4 of the two main bodies 1 synchronously, or it may be led out from the vertical notches 5 synchronously. The different results of the two leading-out methods are that the plane where the dental tape is located is parallel to or perpendicular to the axial direction of the main body 1. The switch of the dental tape between the horizontal notch 4 and the vertical notch 5 is also very convenient, and the switch may be completed by flipping the main body 1 with both hands synchronously. The dental tape drawn out from the horizontal notch 4 is configured to clean all the back teeth, the lower front teeth, while the dental floss drawn out from the vertical notch 5 is suitable for cleaning the upper front teeth.

The dental floss holder of the present disclosure allows the operation of the dental floss by both hands, the cleaning ways of flossing are various, and the force is easy to control, which is conducive for the dental floss to enter and clean teeth smoothly and slowly and is not easy to damage the gums. The distance between the main bodies may be freely controlled by both hands. If the distance between the main bodies is shortened, the dental floss may have more contact with the teeth, and the teeth and gum can be cleaned in a larger range. The tension of the dental floss may be freely controlled by both hands, and the loosening phenomenon will be less.

The above description is only some embodiments of the present disclosure and is not intended to limit the present disclosure. For those of ordinary skill in the art, the present disclosure may have various modifications and variations. Any modification, equivalent replacement, improvement, etc. made within the spirit and principle of the present disclosure shall be included in the protection scope of the present disclosure.

What is claimed is:

1. A two-handle dental floss holder, comprising two main bodies, wherein each of the main bodies comprises a handle and a winding head, the winding head is defined with a horizontal notch and a vertical notch along a top-down direction respectively, the horizontal notch is opened upward, the vertical notch is opened sideward, a vertical bar is arranged beside the vertical notch away from its opening, and a horizontal bar is arranged between the horizontal notch and the vertical notch.

2. The two-handle dental floss holder according to claim 1, wherein a cross section of the winding head is a flat rectangle, and cross sections of the vertical bar and the horizontal bar are rectangular.

3. The two-handle dental floss holder according to claim 1, wherein a rounded corner defines an opening of the vertical notch to facilitate guiding a dental floss to slide into the vertical notch.

4. The two-handle dental floss holder according to claim 2, wherein a rounded corner defines an opening of the vertical notch to facilitate guiding a dental floss to slide into the vertical notch.

5. The two-handle dental floss holder according to claim 1, the horizontal notch and the vertical notch are perpendicular to each other.

6. The two-handle dental floss holder according to claim 2, the horizontal notch and the vertical notch are perpendicular to each other.

7. The two-handle dental floss holder according to claim 3, the horizontal notch and the vertical notch are perpendicular to each other.

8. The two-handle dental floss holder according to claim 4, the horizontal notch and the vertical notch are perpendicular to each other.

9. The two-handle dental floss holder according to claim 1, wherein two rounded corners facing each other defines an opening of the vertical notch to facilitate guiding a dental floss to slide into the vertical notch.

10. The two-handle dental floss holder according to claim 2, wherein two rounded corners facing each other defines an opening of the vertical notch to facilitate guiding a dental floss to slide into the vertical notch.

11. The two-handle dental floss holder according to claim 5, wherein two rounded corners facing each other defines an opening of the vertical notch to facilitate guiding a dental floss to slide into the vertical notch.

12. The two-handle dental floss holder according to claim 6, wherein two rounded corners facing each other defines an opening of the vertical notch to facilitate guiding a dental floss to slide into the vertical notch.

13. The two-handle dental floss holder according to claim 1, wherein each of one tail end of the handle is defined with a through hole.

14. The two-handle dental floss holder according to claim 2, wherein each of one tail end of the handle is defined with a through hole.

15. The two-handle dental floss holder according to claim 3, wherein each of one tail end of the handle is defined with a through hole.

16. The two-handle dental floss holder according to claim 1, a width of each handle is greater than that of the winding head.

17. The two-handle dental floss holder according to claim 2, a width of each handle is greater than that of the winding head.

18. The two-handle dental floss holder according to claim 3, a width of each handle is greater than that of the winding head.

19. A two-handle dental floss holder, comprising two main bodies, wherein each of the main bodies comprises a handle and a winding head, the winding head is defined with a horizontal notch and a vertical notch, the horizontal notch is opened upward, the vertical notch is opened sideward, the horizontal notch is perpendicular to the vertical notch, a vertical bar is arranged beside the vertical notch away from its opening, and a horizontal bar is arranged between the horizontal notch and the vertical notch.

20. A two-handle dental floss holder, comprising two main bodies, wherein each of the main bodies comprises a handle and a winding head, the winding head is defined with a horizontal notch and a vertical notch, the horizontal notch is opened upward, the vertical notch is opened sideward, a vertical bar is arranged beside the vertical notch away from its opening, a horizontal bar is arranged between the horizontal notch and the vertical notch, and the vertical bar is perpendicular to the horizontal bar.
